(19) United States
(12) Patent Application Publication
(10) Pub. No.: US 2022/0176393 A1
(43) Pub. Date: Jun. 9, 2022

(54) Ground-Mounted Soap Injection System

(71) Applicants: Heath Miller, Tallahassee, FL (US); William Dalhoff, Belleair, FL (US)

(72) Inventors: Heath Miller, Tallahassee, FL (US); William Dalhoff, Belleair, FL (US)

(21) Appl. No.: 17/111,787

(22) Filed: Dec. 4, 2020

(51) Int. Cl. B05B 7/30; B05B 15/622; B05B 7/24; B05B 12/00

(52) U.S. Cl. CPC B05B 7/30; B05B 12/002; B05B 7/2486; B05B 15/622

(57) ABSTRACT

A ground-mounted soap injection system that can be used with a SLIP 'N SLIDE or other similar device needing the addition of a lubricating agent. The invention includes a liquid reservoir connected to a metering valve and an injection venturi. A hose is connected to the device and water passing through an internal passage draws the lubricating agent into the moving stream in a controlled fashion. Spikes are provided to secure the device to the ground.

### BACKGROUND OF THE INVENTION

### 1. Field of the Invention

This invention relates to the field of recreational products. More specifically, the invention comprises a ground-mounted liquid injector that can selectively add a secondary liquid to a stream of water moving through a hose.

### 2. Description of the Related Art

FIG. 1 shows a prior art recreational product known as a “SLIP 'N SLIDE.” This product is marketed by Wham-O, Inc., of Carson, Calif., U.S.A. There are now many competing products and Wham-O itself markets many variations. The version shown in FIG. 1 includes the product's primary features but—as those skilled in the art will know—many other features and variations exist in the market. The present invention can be combined with any of the available products.

SLIP 'N SLIDE 10 includes an elongated main panel 12. Water inlet 16 allows hose 26 to be connected to the device. Longitudinal water manifold 14 and lateral water manifold 18 carry the water supplied by the hose. Numerous opening in the two water manifolds produce water streams 20 that fall on main panel 12. The operative concept is to evenly wet main panel 12.

Main panel 12 is made of a slick polymer such as vinyl. When wet this produces a slick surface. Children use the device by running up to the panel, throwing themselves flat on the panel, and sliding along. Numerous straps 22 are provided. Stakes 24 are passed through straps 22 to secure the SLIP 'N SLIDE in position and prevent it sliding when a child uses the device.

SLIP 'N SLIDEs have been in common use since the early 1960s and they work well. However, sometimes a child lands on the main panel at too steep an angle and comes to an abrupt halt rather than sliding along. This problem is avoided by lubricating the main panel. Mild soap can be used for this purpose, with liquid soap working quite well.

Soap placed on the main panel tends to wear off rapidly when the device is used by many children. It is therefore desirable to provide a continuous feed of soap using the water that is already passing through the device. The present invention provides such a solution.

### BRIEF SUMMARY OF THE INVENTION

The present invention comprises a ground-mounted soap injection system that can be used with a SLIP 'N SLIDE or other similar device needing the addition of a secondary liquid such as a lubricating agent. The invention includes a liquid reservoir connected to a metering valve and an injection venturi. A hose is connected to the device and water passing through an internal passage draws the lubricating agent into the moving stream in a controlled fashion.

Spikes are provided to secure the device to the ground. The spikes may be made foldable so that the device is compact when not in use. The reservoir preferably includes a fill opening that can be accessed from the top. This allows the reservoir to be refilled while the device remains secured to the ground.

### BRIEF DESCRIPTION OF THE SEVERAL VIEWS OF THE DRAWINGS

FIG. 1 is a perspective view, showing a prior art SLIP 'N SLIDE entertainment product.

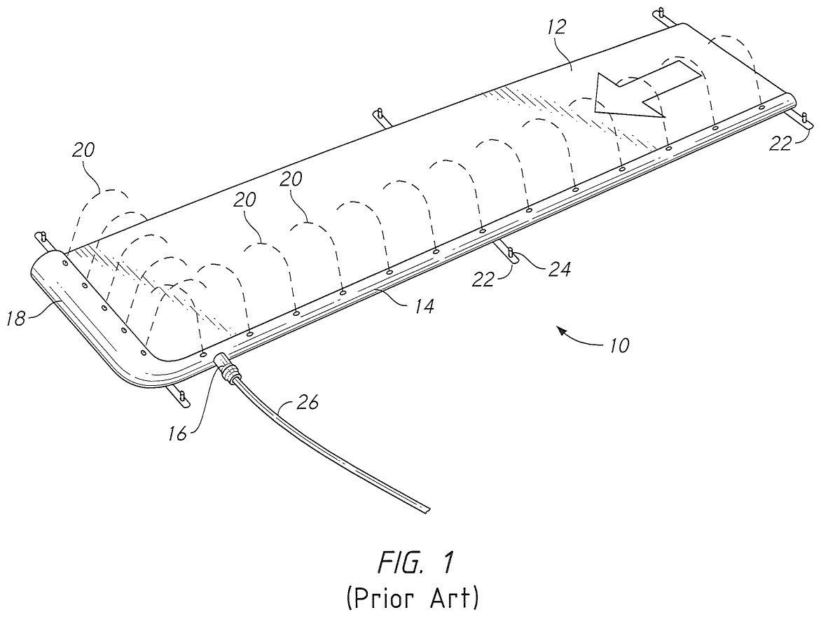

FIG. 2 is a perspective view, showing an embodiment of the present invention attached to a prior art SLIP 'N SLIDE.

FIG. 3 is a perspective view, showing a first embodiment of the present invention.

FIG. 4 is a perspective view, showing the embodiment of FIG. 3 from the opposite side.

FIG. 5 is a perspective view, showing the embodiment of FIG. 3 installed for use.

FIG. 6 is a perspective view, showing the embodiment of FIG. 5 with its reservoir lid open.

FIG. 7 is a sectional elevation view, showing internal features of the liquid injection system.

FIG. 8 is a detailed elevation view, showing the throttle knob in a first position.

FIG. 9 is a detailed elevation view, showing the throttle knob in a second position.

FIG. 10 is a perspective view, showing a second embodiment of the present invention that includes outrigger spikes.

FIG. 11 is a perspective view, showing a third embodiment of the present invention that includes folding spikes.

FIG. 12 is a perspective view, showing the embodiment of FIG. 11 with the spikes deployed.

FIG. 13 is a perspective view, showing a fourth embodiment including a foot-actuated latch on the reservoir lid.

FIG. 14 is a perspective view, showing a reservoir-filling operation for the embodiment of FIG. 13.

### REFERENCE NUMERALS IN THE DRAWINGS

10 SLIP 'N SLIDE
12 main panel
14 longitudinal water manifold
16 water inlet
18 lateral water manifold
20 water streams
22 strap
24 spike
26 hose
28 link hose
30 soap injector
32 body
34 first extension plate
36 second extension plate
38 spike
40 outlet
42 reservoir lid
44 throttle knob
46 hinge assembly
48 inlet
50 latch button
52 reservoir
54 feed inlet
56 throttle valve
58 check valve
60 spring
62 injector outlet
63 venturi
64 water conduit
66 reference mark
68 blade
70 indicator point
72 outrigger
74 spike
76 hinge boss
78 folding outrigger
80 folding spike
82 reservoir lid
84 foot actuated latch
86 pawl

### DETAILED DESCRIPTION OF THE INVENTION

The present invention can be combined with a variety of other devices to provide the injection of a secondary liquid—such as soap. A prior art SLIP 'N SLIDE is used for the explanation of the exemplary embodiments. However, the reader should bear in mind that the invention is by no means limited to this one application. The reader should also bear in mind that the features of the various embodiments can be combined in ways that have not been specifically illustrated.

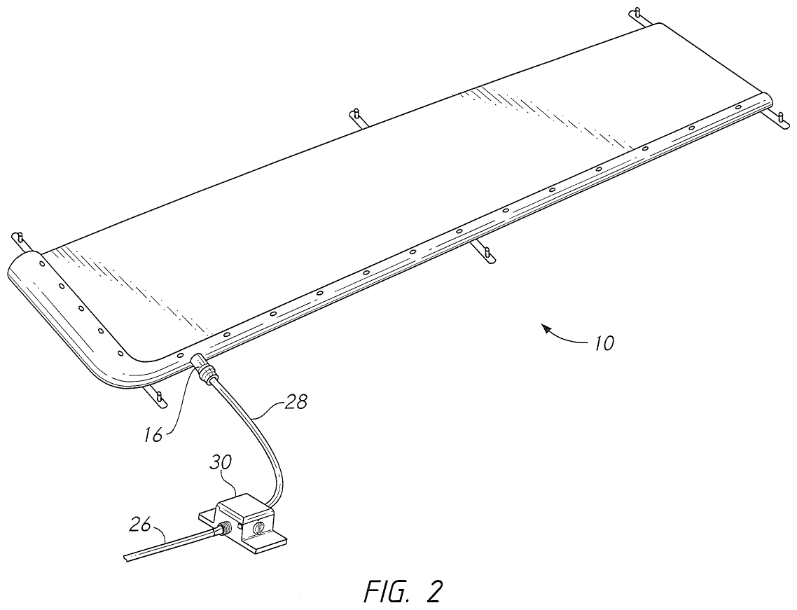

FIG. 2 shows the inventive soap injector 30 being used with a prior art SLIP 'N SLIDE 10 (soap being a good example of a secondary liquid). Hose 26 feeds pressurized water from a source such as an outdoor spigot to soap injector 30. Link hose 28 carries the water from soap injector 30 to water inlet 16 on SLIP 'N SLIDE 10. Link hose 28 may in many instances be longer or shorter than depicted.

Soap dispenser 30 will generally be located near the device it is feeding. It thus presents an obstacle to running children and potentially a trip hazard. It is therefore desirable to include retention features that hold it in place.

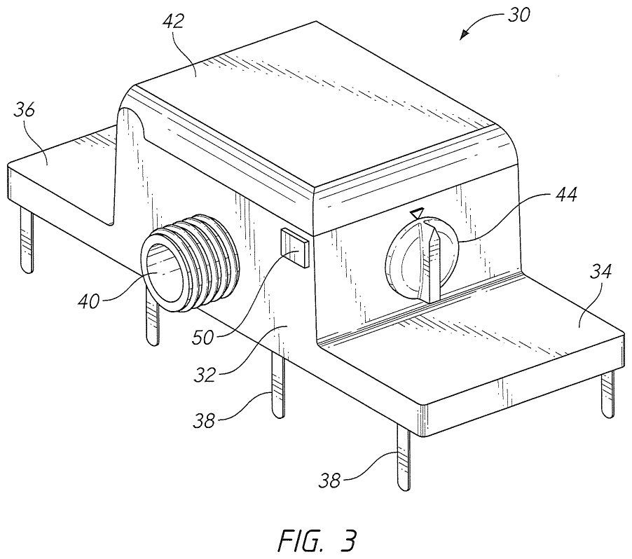

FIGS. 3-9 show a first embodiment of the invention. FIG. 3 shows the outlet side of the soap injector. Outlet 40 is provided on one side of body 32. A reservoir for the secondary liquid (soap) is provided within the body. This reservoir preferably has an upward-facing opening. In the example shown, the reservoir opening is covered by reservoir lid 42. The reservoir lid is hinged so that it can swing open when latch button 50 is pressed.

Throttle knob 44 controls the flow of secondary liquid from the reservoir into a stream of water moving through the soap injector and exiting via outlet 40. The throttle knob controls a throttle valve in the interior of body 32—as will be explained in more detail subsequently.

The soap dispenser is secured to the ground via multiple turf spikes 38. These extend downward from the bottom of body 32. The example shown increases the surface area in contact with the ground by including first extension plate 34 and second extension plate 36. These extend laterally out from body 32. Some of the turf spikes 38 descend downward from the extension plates 34,36. In the example shown, eight turf spikes are used. These are long and slender. The tip is preferably rounded but not pointed. The rounded tip allows the soap dispenser to be pressed downward into the turf, without presenting a hazard when the device is removed from the ground. Reservoir lid 42 is preferably made strong. This configuration allows the user to press downward on the reservoir lid in order to seat the turf spikes. The user can also press downward on the extension plates 34,36.

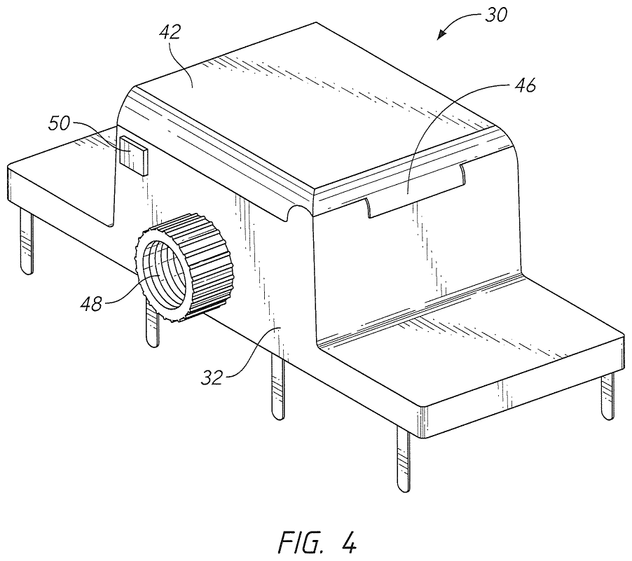

FIG. 4 shows the opposite side of soap injector 30. Pressurized water is fed into the device through inlet 48. The inlet in this example is a rotating female-threaded coupling suitable for receiving the male-threaded end of a garden hose. Gripping features are preferably provided on the rotating portion of the coupling. A second hinge button 50 is provided on the inlet side of body 32.

Hinge assembly 46 pivotally connects reservoir lid 42 to the top of body 32. The hinge assembly can take many forms. In the example shown, the hinge is created by snapping pliable plastic features together. In other examples, a transverse hinge pin can be used or a separate “piano hinge” strip can be added.

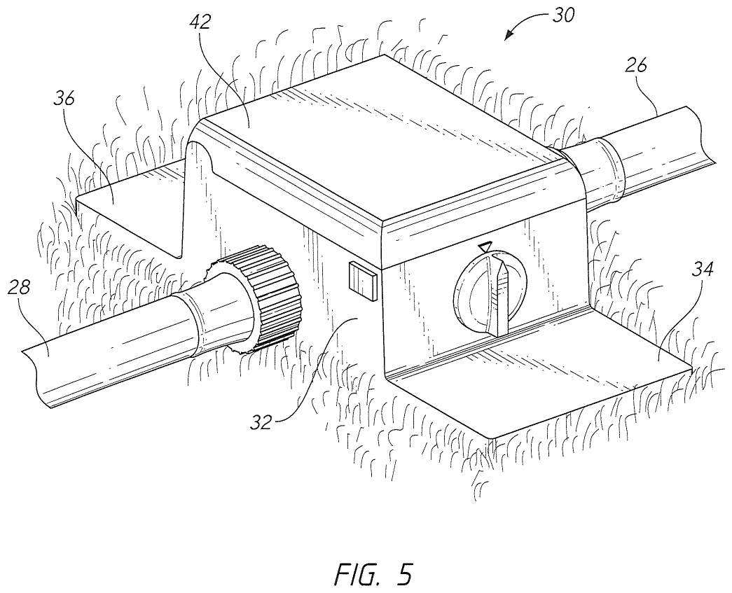

FIG. 5 shows the same embodiment in an installed state. Hose 26 is connected to the inlet and link hose 28 is connected to the outlet. Body 32—including extension plates 34,36—has been pressed down to the turf. The spikes extending downward from the device are at this point embedded in the turf. The result is a stable configuration that will not tend to tip. The overall height of the device is also minimal.

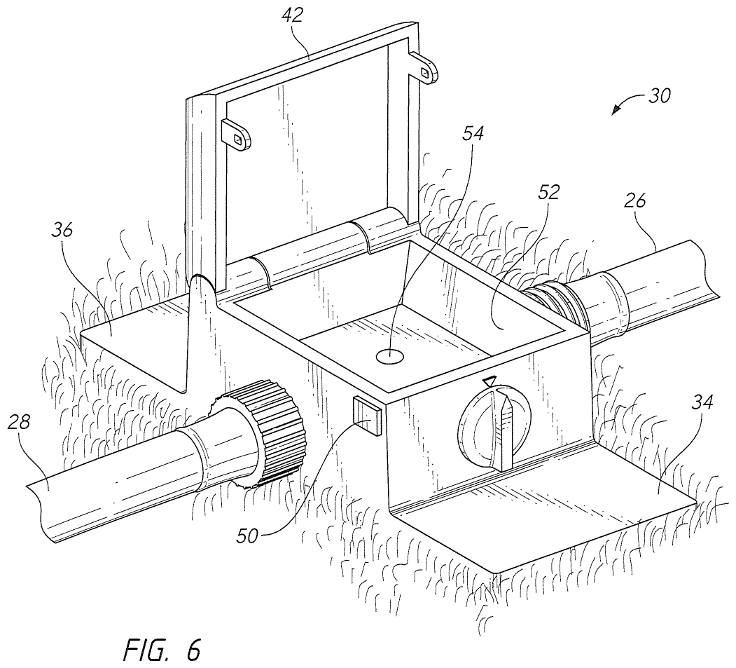

FIG. 6 shows the same embodiment with reservoir lid 42 open. The lid in this example is spring biased toward the open position. When the user presses the two latch buttons 50 (one on each side of the body) reservoir lid 42 pivots upward to the position shown. Reservoir 52 is thereby rendered accessible. A user can fill the reservoir by pouring a secondary liquid into the open top. Feed inlet 54 leads out the bottom of the reservoir.

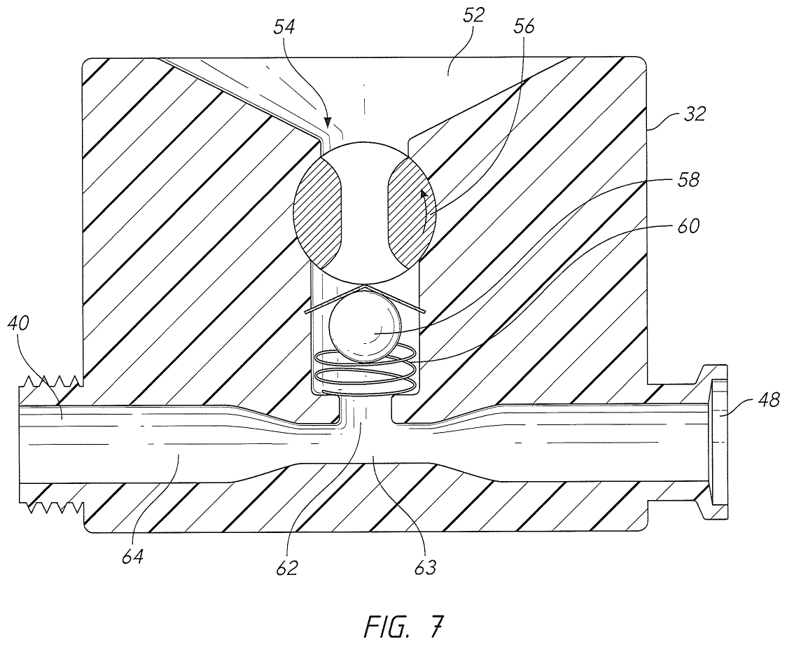

FIG. 7 provides a sectional elevation view through the same embodiment. Water conduit 64 connects inlet 48 to outlet 40. Venturi 63 is provided in the water conduit. The secondary liquid is fed from reservoir 52 down to injector outlet 62, which is located in the venturi. The flow of the secondary liquid is preferably controlled by a throttle valve 56. In the example shown, the throttle valve can be selectively rotated through 90 degrees of travel. The position shown is fully open. If the valve is rotated in the anticlockwise direction the flow through the valve will be more and more restricted until it is finally shut off.

Check valve 58 is preferably also provided so that the secondary liquid within the reservoir will not seep out when the device is not in use but throttle valve 56 is left open. Spring 60 normally biases the check valve to the closed position (typically by urging a sphere against a seat). Thus, when there is no flow of water through water conduit 64 check valve 58 is closed and no liquid escapes the reservoir—even if throttle valve 56 is open.

When water is flowing through water conduit 64 and venturi 63, a region of low pressure is created proximate injector outlet 62. This region of low pressure is explained by Bernoulli's Principle. The water velocity substantially increases as it passes through venturi 63, producing a reduced pressure in injector outlet 62. Reservoir 52 is vented to the atmosphere, so that the pressure on the top of the liquid within the reservoir remains fairly constant. Assuming that throttle valve 56 is at least partially open, the low pressure within the venturi sucks open check valve 58 (overcoming the closing force provided by spring 60) and allows the flow of the secondary liquid into the moving stream of water. The high velocity at the point of injection thoroughly mixes the secondary liquid into the water.

The venturi 63 is preferably sized to account for the fact that the water flowing through the conduit 64 is not simply flowing out an open nozzle. Rather, it is flowing into another dispensing device like a SLIP 'N SLIDE. Thus, the venturi is preferably made small so that suitable flow velocity through the venturi can be obtained even when the flow through conduit 64 is modest.

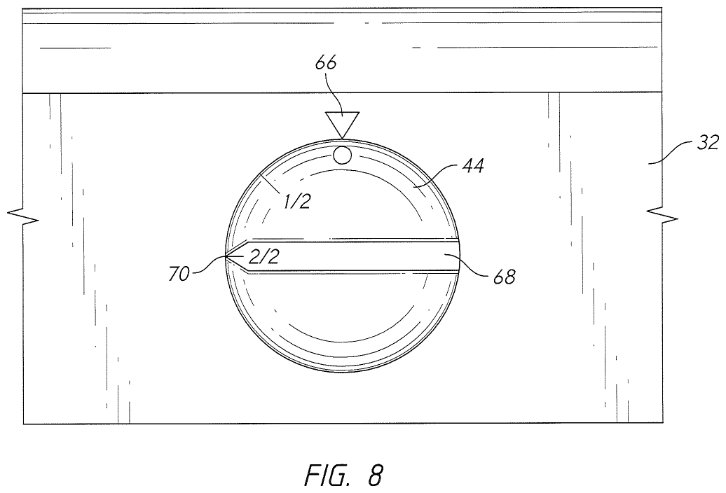

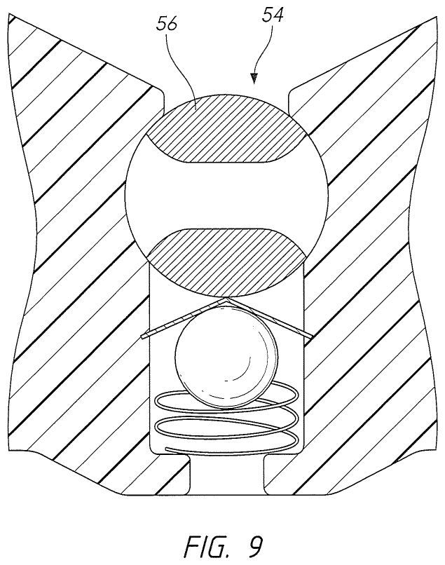

FIGS. 8 and 9 illustrate the operation of the throttle valve. FIG. 8 shows an exterior view of throttle knob 44 on body 32. Reference mark 66 is provided on the body. A gripping blade 68 is provided on the throttle knob and indicator point 70 is provided on the blade. FIG. 8 shows the fully closed position. A “0” is provided on the rotating throttle knob and this “0” is aligned with fixed reference mark 66 in the view. FIG. 9 shows the internal section view through throttle valve 56. The reader will note that the throttle valve is fully closed.

A “1/2” reference is provided on the throttle knob. This reference will align with reference mark 66 if throttle knob 44 is rotated 45 degrees in the clockwise direction from the position shown in FIG. 8. A “2/2” reference is provided on the throttle knob adjacent to indicator point 70. The “2/2” reference will align with reference mark 66 if throttle knob 44 is rotated 90 degrees in the clockwise direction from the position shown in FIG. 8 (the corresponding fully open position of the throttle valve is shown in FIG. 7).

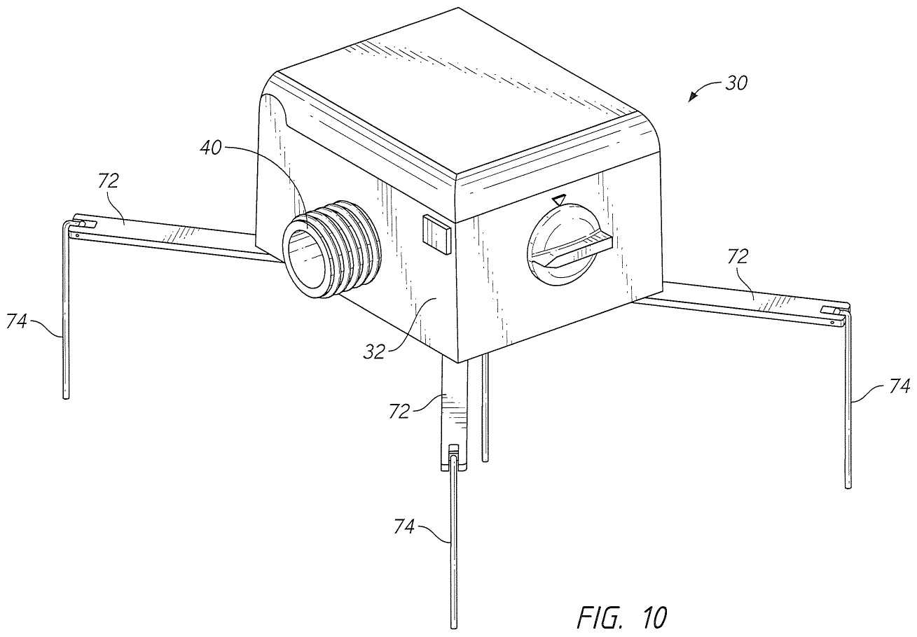

FIGS. 10-12 illustrate some alternate embodiments. In the version of FIG. 10, body 32 is mounted on an “X-pattern” set of metal outriggers 72. Each outrigger includes a large descending spike 74. The outriggers and spikes are securely attached to the base of the body so that the assembly can be secured by pressing the spikes into the turf. The other features of this embodiment are the same as for the embodiment of FIG.3.

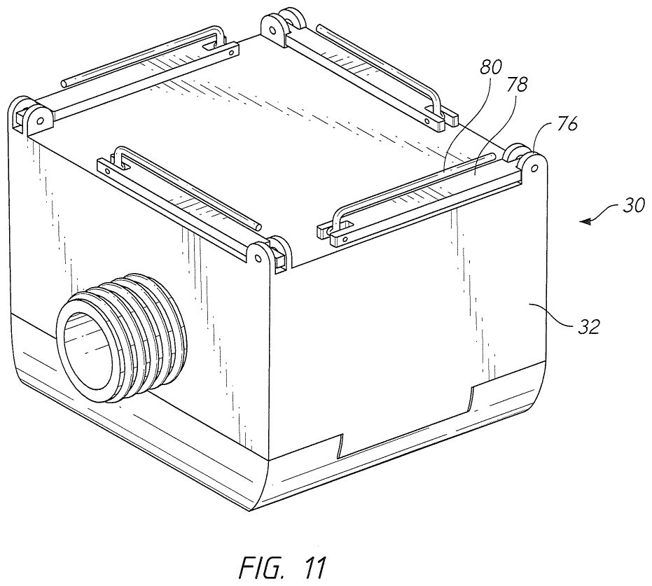

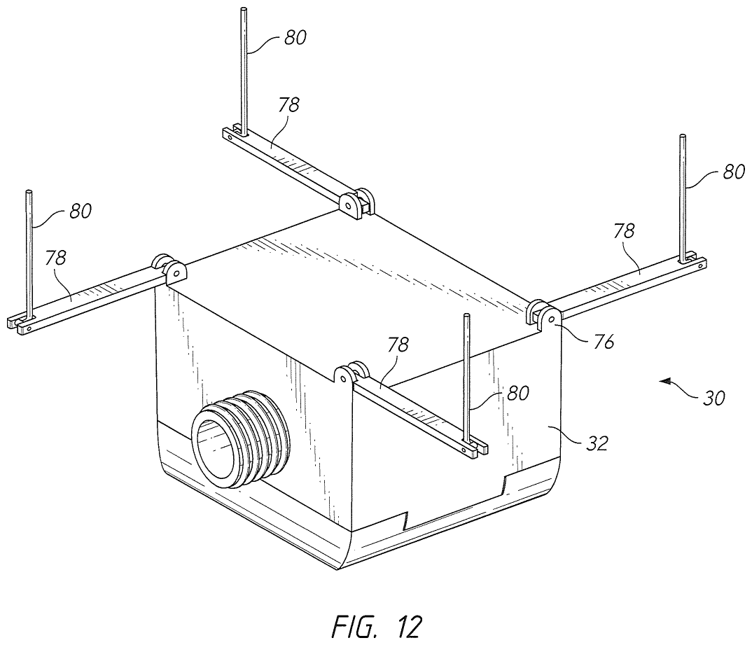

FIGS. 11 and 12 shows still another embodiment in which the spikes can be folded for compact storage. FIG. 11 shows the device in an inverted state. The underside of body 32 includes four hinge bosses 76. Each hinge boss pivotally attaches a folding outrigger 78 to body 32. Each folding outrigger 78 includes a folding spike 80.

In operation the four folding outriggers 78 are pivoted into a deployed position where they snap into place. The spikes are then folded down from the outriggers. FIG. 12 shows this deployed state (with the body still being shown in an inverted orientation). The deployed assembly is then flipped upright and the folding spikes 80 are pressed into the turf in order to secure the dispenser.

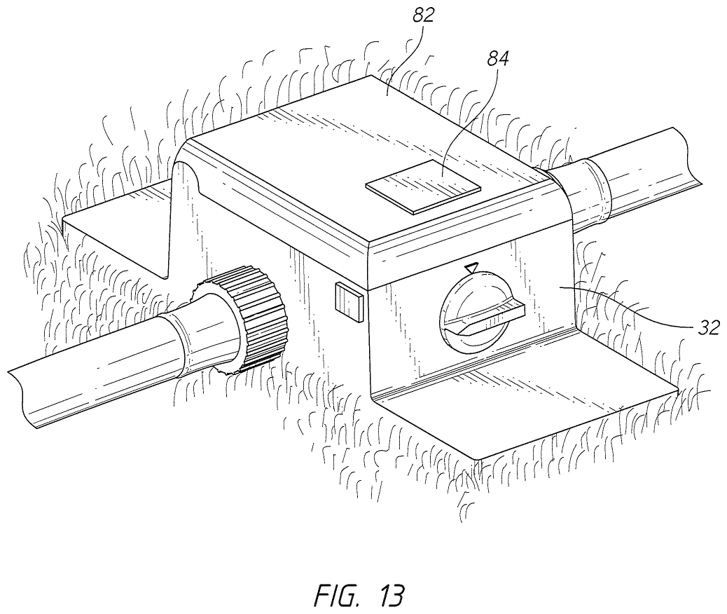

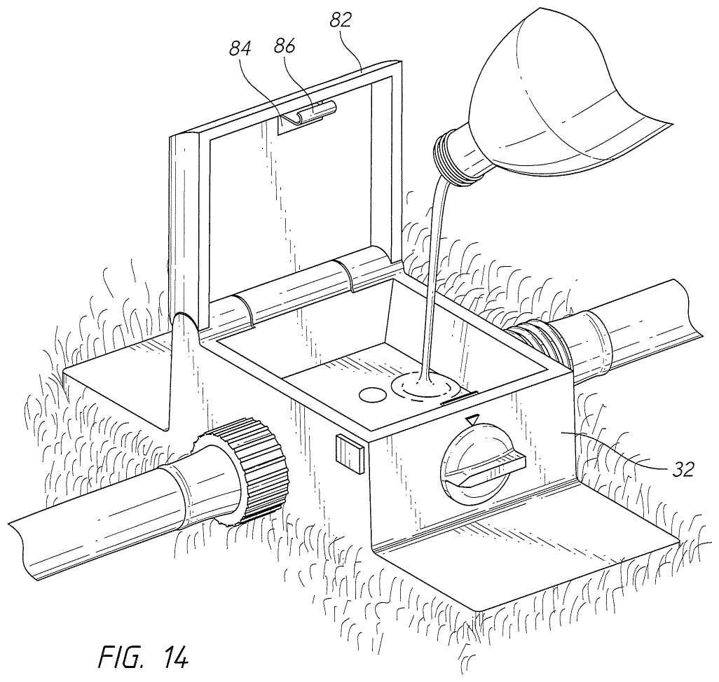

FIGS. 13 and 14 show yet another embodiment in which the reservoir lid is configured to be actuated by a user's foot. FIG. 13 shows reservoir lid 82 in the closed position. The lid includes foot-actuated latch 84. When a user steps on foot-actuated latch 84, reservoir lid 82 is released and the lid then pivots to the open position. FIG. 14 shows this position.

Pawl 86 has been released from its home position—in which it engages body 32. Once released, a rotary spring pivots the lid up to the position shown in FIG. 14. A user can then add soap to the open reservoir top. Once the desired amount of soap has been added, the user can use his or her foot to push to the lid closed again. Pawl 86 automatically re-engages when the lid is pressed closed.

The reader will therefore understand how the present invention provides a device for metering a desired secondary liquid (such as soap) into a moving stream of water. The invention has other features, including:

1. The throttle valve can set and maintain a precise ratio of added secondary liquid;

2. A transparent strip indicator window can be provided on the side of the body so that the user can observe the level of secondary liquid in the reservoir;

3. The link hose can be provided as part of the soap dispenser; and

4. The invention can include quick-connect fittings for the connected hoses rather than threaded fittings.

The preceding description contains significant detail regarding the novel aspects of the present invention. It should not be construed, however, as limiting the scope of the invention but rather as providing illustrations of the preferred embodiments of the invention. Many other embodiments will be made apparent to those skilled in the art. Thus, the scope of the invention should be fixed by the following claims, rather than by the examples given.

Having described our invention, we claim:

1. A secondary liquid injection system configured to be attached to a ground, comprising:
(a) a body, having a bottom;
(b) a plurality of spikes attached to said body and protruding downward below said bottom;
(c) a hose inlet;
(d) a hose outlet;
(e) a water conduit connecting said hose outlet to said hose inlet, said water conduit including a venturi;
(f) a reservoir in said body configured to hold said secondary liquid;
(g) an injector outlet in said venturi; and
(h) a throttle valve controlling flow from said reservoir to said injector outlet.

2. The secondary liquid injection system as recited in claim 1, further comprising a check valve between said reservoir and said injector outlet, wherein said check valve is configured to allow flow from said reservoir to said injector outlet but prevent flow in the opposite direction.

3. The secondary liquid injection system as recited in claim 2, wherein:
(a) said water conduit lies proximate said bottom of said body;
(b) said check valve lies above said venturi;
(c) said throttle valve lies above said check valve; and
(d) said reservoir lies above said throttle valve.

4. The secondary liquid injection system as recited in claim 1, wherein said reservoir lies above said injector outlet.

5. The secondary liquid injection system as recited in claim 1, wherein said reservoir has an open top that is selectively closed by a reservoir lid.

6. The secondary liquid injection system as recited in claim 1, wherein:
(a) said body includes a first lateral extension plate;
(b) said body includes a second lateral extension plate; and
(c) some of said plurality of spikes descend from said first and second lateral extension plates.

7. The secondary liquid injection system as recited in claim 1, wherein:
(a) said body includes a plurality of outriggers; and
(b) some of said plurality of spikes descend from said outriggers.

8. The secondary liquid injection system as recited in claim 1, wherein said spikes are configured to fold flat.

9. A secondary liquid injection system configured to be attached to a ground, comprising:
(a) a hose inlet;
(b) a hose outlet;
(c) a water conduit connecting said hose outlet to said hose inlet, said water conduit including a venturi;
(d) a reservoir configured to hold said secondary liquid, said reservoir lying above said venturi;
(e) an injector outlet in said venturi;
(f) a throttle valve controlling flow from said reservoir to said injection outlet; and
(g) a plurality of spikes configured to secure said injection system to said ground.

10. The secondary liquid injection system as recited in claim 9, further comprising a check valve between said reservoir and said injector outlet, wherein said check valve is configured to allow flow from said reservoir to said injector outlet but prevent flow in the opposite direction.

11. The secondary liquid injection system as recited in claim 10, wherein:
(a) said water conduit lies within a body and proximate a bottom of said body;
(b) said check valve lies above said venturi;
(c) said throttle valve lies above said check valve; and
(d) said reservoir lies above said throttle valve.

12. The secondary liquid injection system as recited in claim 9, wherein said reservoir has an open top that is selectively closed by a reservoir lid.

13. The secondary liquid injection system as recited in claim 9, wherein:
(a) said reservoir is housed within a body;
(b) said body includes a first lateral extension plate;
(c) said body includes a second lateral extension plate; and
(d) some of said plurality of spikes descend from said first and second lateral extension plates.

14. The secondary liquid injection system as recited in claim 9, wherein:
(a) said reservoir is housed within a body;
(b) said body includes a plurality of outriggers; and
(c) some of said plurality of spikes descend from said outriggers.

15. The secondary liquid injection system as recited in claim 9, wherein said spikes are configured to fold flat.

16. A secondary liquid injection system configured to be attached to a ground, comprising:
(a) a body having a hose inlet, a hose outlet, and a water conduit running therebetween;
(b) a venturi in said water conduit;
(c) a reservoir configured to hold said secondary liquid, said reservoir lying above said venturi;
(d) an injector outlet in said venturi; and
(e) a throttle valve controlling flow from said reservoir to said injection outlet.

17. The secondary liquid injection system as recited in claim 16, further comprising a check valve between said reservoir and said injector outlet, wherein said check valve is configured to allow flow from said reservoir to said injector outlet but prevent flow in the opposite direction.

18. The secondary liquid injection system as recited in claim 16, wherein:
(a) said water conduit lies proximate a bottom of said body;
(b) said check valve lies above said venturi;
(c) said throttle valve lies above said check valve; and
(d) said reservoir lies above said throttle valve.

19. The secondary liquid injection system as recited in claim 16, wherein said reservoir has an open top that is selectively closed by a reservoir lid.

20. The secondary liquid injection system as recited in claim 16, wherein:
(a) said body includes a first lateral extension plate;
(b) said body includes a second lateral extension plate; and
(d) some of said plurality of spikes descend from said first and second lateral extension plates.
